(19) United States
(12) Patent Application Publication
(10) Pub. No.: US 2004/0098708 A1
(43) Pub. Date: May 20, 2004

(54) Simulator for software development and recording medium having simulation program recorded therein

(76) Inventors: Maiko Taruki, Kitakyusyu (JP); Tsuyoshi Nakamura, Kasuya-Gun (JP); Takahiro Kondou, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/667,373

(22) Filed: Sep. 23, 2003

(30) Foreign Application Priority Data
Sep. 26, 2002 (JP) 2002-280827

(51) Int. Cl. G06F 9/45

(52) U.S. Cl. 717/138; 703/22

(57) ABSTRACT

The library contains a plurality of functions and a plurality of procedures that model hardware-components of the target processor. The plurality of functions and/or a plurality of procedures are defined and described in a high-level language, e.g. C-language. All of software development can be done in the high-level language; a common source code can be used in two types (compiler type and interpreter type) of simulators without rewriting the source code. Parts of the simulators can be communalized and development efficiency improves. The executing-cycles-number is acquired and measurable.

### BACKGROUND OF THE INVENTION

1. Field of the Invention

The present invention relates to a simulator designed for development of target processor-adapted built-in software, and an art related thereto.

2. Description of the Related Art

In general, a software development system run on a host processor is used to develop target processor-adapted built-in software. The host processor is incompatible with a target processor.

The term “host processor” as set forth herein actuates the software development system. The host processor is used for software development and the verification of the resulting software.

The term “target processor” as given herein differs from the host processor. The target processor is used to execute development results or rather the resulting software.

The host processor is incompatible in software with the target processor. The resulting software normally runs only on the target processor, not on the host processor.

The term “simulator” as set forth herein creates resulting software-like, simulated software that is executed on the host processor, not on the target processor.

As described above, the software designed for the target processor that differs from the host processor is developed using the host processor-adapted software development system. However, such software development involves problems as discussed below.

A recent trend of the above-discussed software development has been changed, with an increase in scale of software, from assembler language-driven development to high-level language-driven development (e.g., C/C++).

This is because the software development using high-level languages allows processing such as data retention, transfer, and computation to be described independently of target processor assembler instructions and resources such as a register and a memory. This means that the high-level language-led software development is superior in readability, versatility, and development efficiency.

In particular, built-in software must be optimized to maximize processor capability in order to provide utmost system performance.

However, the high-level language-based software development has a compiler performance problem that generates a redundant code upon transformation from any high-level language into an assembler code. This problem may adversely affect software code size and execution speed.

In order to smooth out the problem, software development associated with heavy load-involving processing such as signal processing is still now made using a target processor-adapted assembler language in addition to the high-level language-based software development.

The use of the target processor-adapted assembler language makes the efficiency of software development low.

In a field of build-in software development, since the software development is large in scale and complicated, production process tends to be huge. In addition, increase of verification process and simulation time is also remarkable.

In many cases, the software development must be started, being unable to obtain the target processor, since the target processor has not completed yet.

Performance of the software should be analyzed also in a phase that software development environment is not prepared enough.

However, it is difficult to get precise information for a short time, since a simulator cannot run rapidly enough to meet with large-scaling and complication of LSIs.

According to the prior art, preparing software development environment (e.g. a compiler and a simulator) needs a lot of man-days. It tends to be delayed to start development of target software using the software development environment.

### OBJECTS AND SUMMARY OF THE INVENTION

In the view of above, an object of the present invention is to provide simulators (compiler type and interpreter type) that can help software development more efficiently than the prior art.

More particularly, the present invention provides simulators that can simulate, optimizing both code size and executing-speed in an assembler level, using common software described all in a high-level language.

A first aspect of the present invention provides a simulator comprising: a compiler operable to compile a source code described in a high-level language; and a library including functions and/or procedures that are defined in the high-level language and model components of a target processor different from a host processor, wherein the source code is described using the library.

In the library, the hardware-components of the target processor are modeled using the functions and/or the procedures. The source code is described using the library. Thereby, a compiler type simulator can be constituted.

Since an object-code that the compiler type simulator outputs can be executed without passing through processes, such as instruction-fetching processes and instruction-decoding processes, executing-speed is high.

Since all source code is described in the high-level language, the development is excellent in portability or readability and the software development, including optimization in an assembler level, can be done all in the high-level language.

As mentioned later, this source code can be used in both the compiler type simulator and the interpreter type simulator. In development of two types (compiler type and interpreter type) of simulators, common parts can be used, thereby improving development efficiency.

A second aspect of the present invention provides a simulator as defined in the first aspect of the present invention, wherein the components of the target processor further comprising: an accumulator of the target processor; a memory controller of the target processor; and a register of the target processor.

With this structure, the functions and/or the procedures can express behavior of an accumulator and a memory controller that are important components of the target processor.

A third aspect of the present invention provides a simulator as defined in the first aspect of the present invention, wherein the library further comprising: a hardware model library defining in the high-level language the functions and/or the procedures that model the components of the target processor; and an instruction-set-library defining in the high-level language functions and/or procedures corresponding to instructions of the target processor using the functions and/or the procedures of the hardware model library.

In this structure, since the library is divided into the hardware model library and the instruction-set-library, thereby handling of the library becomes easy.

That is, the hardware model library is shared with an interpreter type simulator mentioned later, and the instruction-set-library is added to the compiler type simulator.

In other words, the compiler type simulator according to this structure is constructed only by adding the instruction-set-library to the hardware model library, and since the translator and so on are unnecessary, the compiler type simulator can be more simply constituted than the interpreter type simulator.

For this reason, man-days of simulator development decrease and the simulator can be supplied to a developer early.

A fourth aspect of the present invention provides a simulator as defined in the third aspect of the present invention, wherein the instructions of the target processor comprises an ADD instruction, an SUB instruction, an AND instruction, an OR instruction, an LD instruction, an ST instruction, an SET instruction and an MOV instruction.

With this structure, important instructions of the target processor can be covered.

A fifth aspect of the present invention provides a simulator as defined in the first aspect of the present invention, wherein the functions and/or the procedures of the library further comprising a function and/or a procedure calculating at least one of an executing-cycles-number of the target processor and power consumption of the target processor.

With this structure, the functions and/or procedures that are included in the library calculate and output an executing-cycles-number, power consumption, and so on. When simulation terminates, the executing-cycles-number of an assembler program, power consumption, and so on can be obtained, and performance can be analyzed in the compiler type simulator.

A sixth aspect of the present invention provides a simulator as defined in the first aspect of the present invention, wherein at least one of an executing-cycles-number of the target processor and power consumption of the target processor can be changed.

With this structure, changing intentionally the executing-cycles-number, power consumption can perform the simulation under various conditions.

A seventh aspect of the present invention provides a simulator as defined in the first aspect of the present invention, the functions and/or the procedures of the library further comprising a function and/or a procedure calculating code size in the target processor.

With this structure, optimization in code size and performance analysis can be performed.

An eighth aspect of the present invention provides a simulator comprising: a translator operable to read an source code described in a high-level language to output an object-code; an instruction-fetching unit operable to fetch the object-code to output an fetched object-code; an instruction-decoding unit operable to output an decoded object-code; an executing unit operable to execute the decoded object-code; and a library including functions and/or procedures that are defined in the high-level language and model components of a target processor different from a host processor, wherein the source code is described using the library.

With this structure, an interpreter type simulator can be constituted.

In addition, the source code of the interpreter type simulator can be used in the compiler type simulator mentioned above. Since programs being executed in two types of simulators (compiler type and interpreter type) can be unified to one common program, thereby development efficiency of the programs can be improved compared with the prior art.

The above, and other objects, features and advantages of the present invention will become apparent from the following description read in conjunction with the accompanying drawings, in which like reference numerals designate the same components.

### BRIEF DESCRIPTION OF THE DRAWINGS

FIG. 1 is a block diagram of software development environment according to a first embodiment of the present invention;

FIG. 2 is a block diagram of the target processor according to the first embodiment of the present invention;

FIG. 3(a) is an illustration showing an example of the instructions of the target processor according to the first embodiment of the present invention;

FIG. 3(b) is an illustration showing an example of register assignment of the target processor according to the first embodiment of the present invention;

FIG. 4(a) is a model drawing of an accumulator according to the first embodiment of the present invention;

FIG. 4(b) is a model drawing of a memory controller according to the first embodiment of the present invention;

FIG. 5 is an illustration showing an example of a header file of the hardware model library according to the first embodiment of the present invention;

FIG. 6 is an illustration showing an example of an implement file of the hardware model library according to the first embodiment of the present invention;

FIG. 7 is an illustration showing an example of the implement file of the instruction-set-library according to the first embodiment of the present invention;

FIG. 8(a) is an illustration showing an example of a header file of the instruction-set-library according to the first embodiment of the present invention;

FIG. 8(b) is an illustration showing an example of the source code according to the first embodiment of the present invention;

FIG. 9(a) is a flow chart of processing of the interpreter type simulator according to the first embodiment of the present invention;

FIG. 9(b) is a flow chart of processing by an assembler;

FIG. 10 is an illustration showing an example of an implement file of the interpreter type simulator according to the first embodiment of the present invention;

FIG. 11 is an illustration showing an example of an implement file of the hardware model library according to the second embodiment of the present invention;

FIG. 12 is an illustration showing an example of an implement file of the instruction-set-library according to the second embodiment of the present invention;

FIG. 13 is an illustration showing an example of a source code according to the second embodiment of the present invention;

FIG. 14 is an illustration showing an example of an implement file of the instruction-set-library according to a third embodiment of the present invention;

FIG. 15(a) is an illustration showing an example of arrays according to the third embodiment of the present invention; and

FIG. 15(b) is an illustration showing an example of a source code according to the third embodiment of the present invention.

### DETAILED DESCRIPTION OF THE PREFERRED EMBODIMENTS

Preferred embodiments of the present invention are now described in conjunction with the accompanying drawings.

In advance of concrete explanation, shortly, a high-level language in this specification is explained and functions and/or procedures thereof are described. In each following embodiment, C-language is used as the high-level language.

Herein, on the specification of C-language, not only a process with a return value but also a process without a return value (void type) is called a “function”.

However, in other high-level languages, for example, Pascal, a process with a return value is called a “function”, but a process without a return value is called a “procedure”, and procedures and functions are strictly distinguished.

Here, the high-level language in this specification is not limited to C-language, but includes one of other high-level languages well known, for example, C++ language having upward compatibility with C-language, Pascal, and so on.

Taking Pascal into consideration, in the library of this specification, hardware-components of the target processor are modeled by “functions and/or procedures”, in general. Each of these functions and/or procedures corresponding to one of instructions of the target processor is defined and described using the high-level language.

(First Embodiment)

Next, the concrete configuration of this embodiment will now be explained.

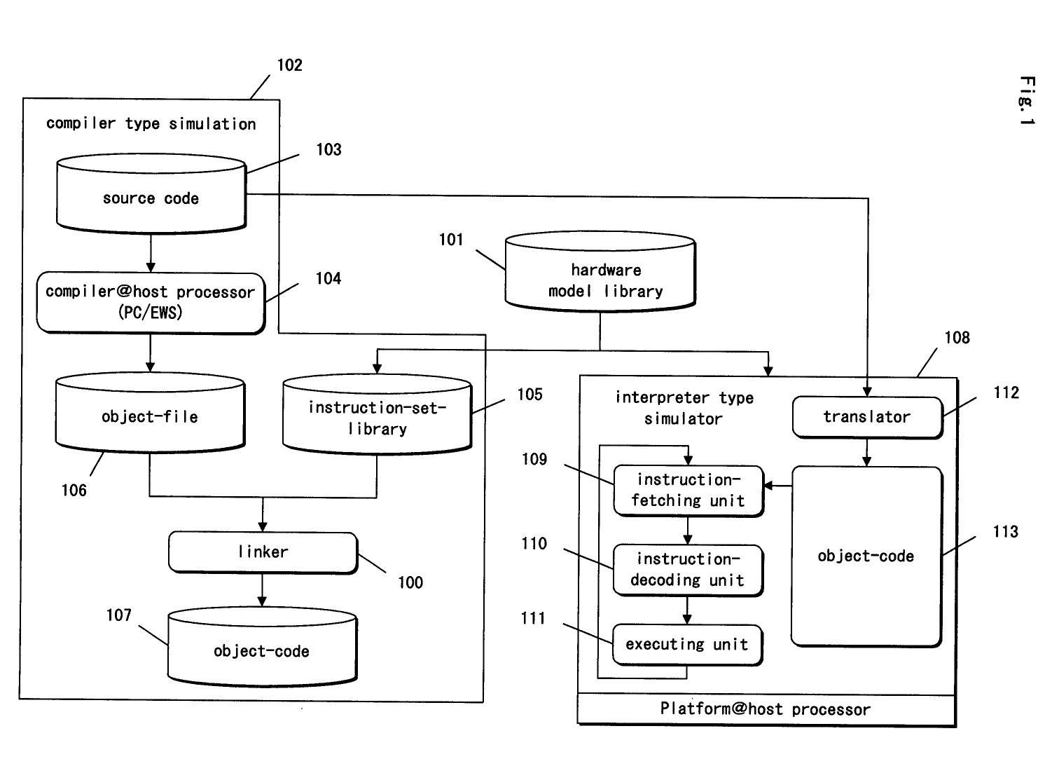

FIG. 1 is a block diagram of the software development environment in the first embodiment of the present invention.

Roughly speaking, this development environment comprises two kinds of simulators of a compiler type simulator 102 and a interpreter type simulator 108.

Of course, a simulator of the present invention can also make a compiler type simulator or an interpreter type simulator independently. Such independently made simulators are also included in the present invention.

As shown in FIG. 1, both of the compiler type simulator 102 and the interpreter type simulator 108 use a same hardware model library 101.

The hardware model library 101 defines functions, variables, and so on, modeling the hardware-components (accumulators, memory controllers, registers, and so on.) of the target processor in C-language, as mentioned below in detail using an example of a source code.

An instruction-set-library 105 defines, in C-language, functions corresponding to instructions of the target processor, using functions in the hardware model library 101.

The library of this embodiment comprises the hardware model library 101 and the instruction-set-library 105.

For performance analysis of software using the compiler type simulator 102, functions that calculate an executing-cycles-number, power consumption, resource usage, and so on are included in the library.

The hardware model library 101 is applied common to two kinds of software simulators, the compiler type simulator 102 and the interpreter type simulator 108.

In the library, variables and functions realizing hardware components in the target processor are prepared. The variables and functions in the library are used as components of both the compiler type simulator and the interpreter type simulator.

Next, the compiler type simulator 102 is explained in general.

A source code 103 is a C-language program described using definitions of the hardware model library 101 and the instruction-set-library 105. This source code 103 is also a source code of the interpreter type simulator 108.

A compiler 104 is a compiler of C-language that runs on the host processor. The compiler 104 does not have to be specific, one of usual C-compilers may be used as this compiler 104. The compiler 104 compiles the source code 103 to output an object file 106.

The instruction-set-library 105 has already been compiled and has become a form of an object file, before compiling the source code 103.

A linker 100 links the object file 106 and the instruction-set-library 105 (object file) to output an object-code 107 of a machine language of the host processor.

As mentioned above, this object-code 107 operates on the host processor, and, does not operate on the target processor in general.

Next, the interpreter type simulator 108 will now be explained.

A translator 112 translates the source code 103 described in C-language into an object-code 113 for the target processor.

When executing, the instruction-fetching unit 109 reads one instruction of the object-code 113 to output the fetched object-code correspond to the instruction, the instruction-decoding unit 110 decodes the fetched object-code to output decoded object-code correspond to the instruction, and the executing unit 111 executes the decoded object-code.

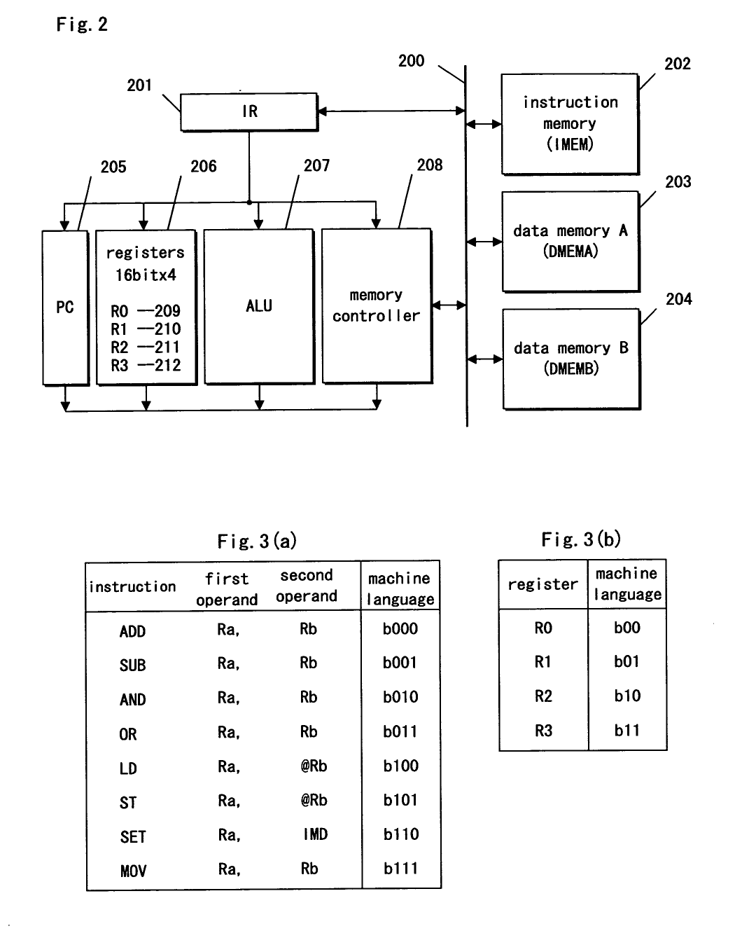

Referring now to FIG. 2, a configuration of the target processor assumed with this embodiment is explained. FIG. 2 is a block diagram of the target processor used by the first embodiment of the present invention.

FIG. 2 shows just an example of the target processor of course and the present invention can be similarly applied to the target processors that take other configurations.

The target processor shown in FIG. 2 comprises the following components.

An instruction register (IR) 201 is a register holding an executing instruction.

A program counter (PC) 205 is a register holding an address of the executing instruction.

Registers 206 hold data and operation results that have been read from a memory mentioned later, and are constituted by four 16-bits registers in this embodiment.

These registers 206 are called a register R0 (209), a register R1 (210), a register R2 (211), and a register R3 (213), respectively.

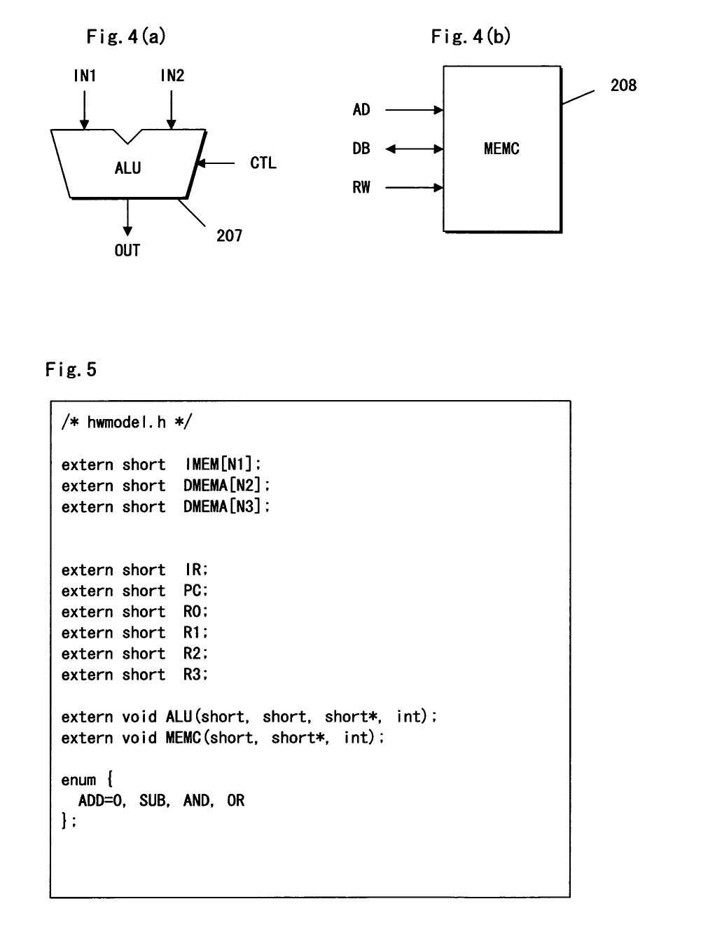

As shown in FIG. 4(a), an accumulator (ALU) 207 is a unit that performs four kinds of 16-bits binary operations (addition (ADD), subtraction (SUB), logical operations (AND, OR), and comprises two data inputs (IN1, IN2), one data output (OUT), and one control signal (CTL).

As shown in FIG. 4(b), a memory controller 208 is a unit that controls access to data memory A (203) and data memory B (204), and selects a data memory to be accessed using an address value.

In FIG. 4(b), an AD signal expresses an address value of a memory to be accessed. A DB signal is a pointer.

When reading, the memory controller 208 reads data from a memory variable and stores the data in a pointer pointed out by the DB signal.

When writing, the memory controller 208 reads data pointed out by the DB signal and stores the data in the memory variable.

RW signal is a control signal showing read/write.

In FIG. 2, the following memories are connected to the target processor via a bus 200.

An instruction memory (IMEM) 202 is a memory for storing a program, and a data memory A (203) and a data memory B (204) are memories in which the target processor stores data for calculation.

Referring now to FIG. 3, instructions of the target processor will be explained. FIG. 3(a) is an illustration showing an example of the instructions of the target processor in the first embodiment of the present invention.

As shown in FIG. 3(a), this target processor has eight kinds of instructions, an ADD instruction, an SUB instruction, an AND instruction, an OR instruction, an LD instruction, an ST instruction, an SET instruction, and an MOV instruction.

The target processor follows rules shown in FIG. 3(b), concerning assignment of registers.

In the ADD instruction, the target processor adds data stored in a second-operand register to data stored in a first-operand register to store a result in the first-operand register.

In the SUB instruction, the target processor subtracts data stored in the second-operand register from data stored in the first-operand register to store a result in the first-operand register.

In the AND instruction, the target processor calculates an AND of data stored in the first-operand register and data stored in the second-operand register to store a result in the first-operand register.

In the OR instruction, the target processor calculates an OR of data stored in the first-operand register and data stored in the second-operand register to store a result in the first-operand register.

In the LD instruction, regarding data stored in a register assigned by the second-operand register as an address of one of the data memory A (203) and the data memory B (204), the target processor reads data at the address and stores the data into the first-operand register.

In the ST instruction, the target processor regards data in the second-operand register as an address of one of the data memory A (203) and the data memory B (204), and stores the data in the first-operand register into the address.

In the SET instruction, the target processor stores an immediate data assigned by the second operand into the first-operand register.

In the MOV instruction, the target processor stores data in the second-operand register into the first-operand register.

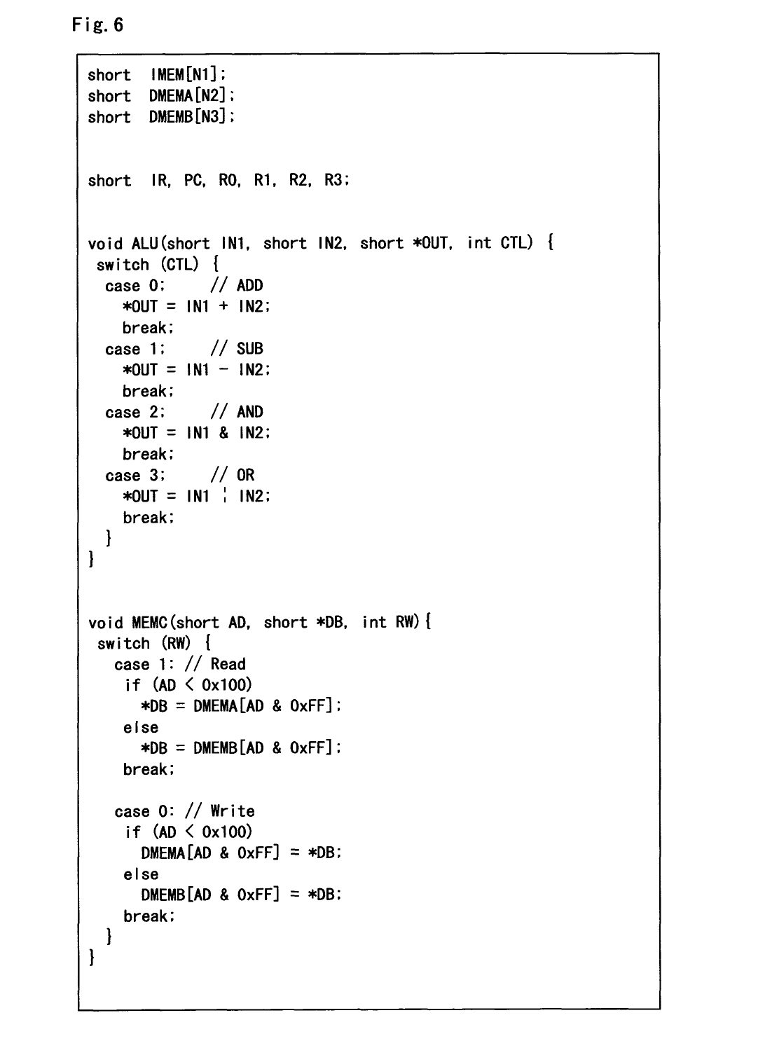

Referring now to FIG. 5 and FIG. 6, an example of a configuration of the hardware model library 101 that models each component of the target processor shown in FIG. 2 is described.

FIG. 5 is an illustration showing an example of a header file of a hardware model library, and FIG. 6 shows an example of an implement file of the hardware model library in the first embodiment of the present invention.

The same name is given to each of the program components corresponding to the components in FIG. 2 and FIG. 3.

For example, a name of “IMEM” is given to a program component corresponding to the instruction memory (IMEM) 202 in FIG. 2.

Declarations of variables and/or functions are made using the header file as shown in FIG. 5, and the implement file of FIG. 6 has been described concerning the contents of the variables and the functions.

However, it is not necessary to divide the hardware model library into the header file and the implement file, that is, all items of the hardware model library may be described in one file.

As shown in FIGS. 4 and 5, arrays IMEM, DMEMA, and DMEMB express instruction memory 202, data memory A (203), and data memory B (204), each having components described by the respective sizes.

Of course, a data structure that models one of the memories 202, 203 and 204 does not have to be an array, and other well known structures (e.g. list) may be used instead.

The variables IR, PC, R0, R1, R2 and R3 express, respectively, an instruction register (IR) 201, a program counter (PC) 205, a register (RO) 209, a register (RI) 210, a register (R2) 211, and a register (R3) 213, and are defined as short type variables, that is, 16-bits integer type.

As shown in FIG. 4(a), an ALU function having four arguments of variables IN1, IN2, OUT, and CTL expresses an accumulator (ALU) 207.

The variables IN1 and IN2 express two data inputs and are short type pointers.

The variable OUT expresses a data output and is a short type pointer.

The variable CTL expresses a control signal and is an int type variable.

The ALU function is described in C-language such that the ALU function has the same calculation precision as the target processor.

As shown in FIG. 4(b), an MEMC function having three arguments of variables AD, DB, and RW expresses the memory controller (MEMC) 208.

The variable AD expresses an address value to be accessed.

The variable DB is a pointer. The MEMC function, when reading, reads data from a memory variable to store the data in a pointer assigned by the variable DB, when writing, the MEMC function reads data assigned by the variable DB to store the data in the memory variable.

The variable RW is a control signal showing read/write.

In this embodiment, the hardware model library 101 comprises the above nine variables (arrays are also included) IMEM, DMEMA, and DMEMB, IR, PC, RO, R1, R2 and R3, and two library functions (ALU function, MEMC function). Needless to say, more or less variables and functions may be used.

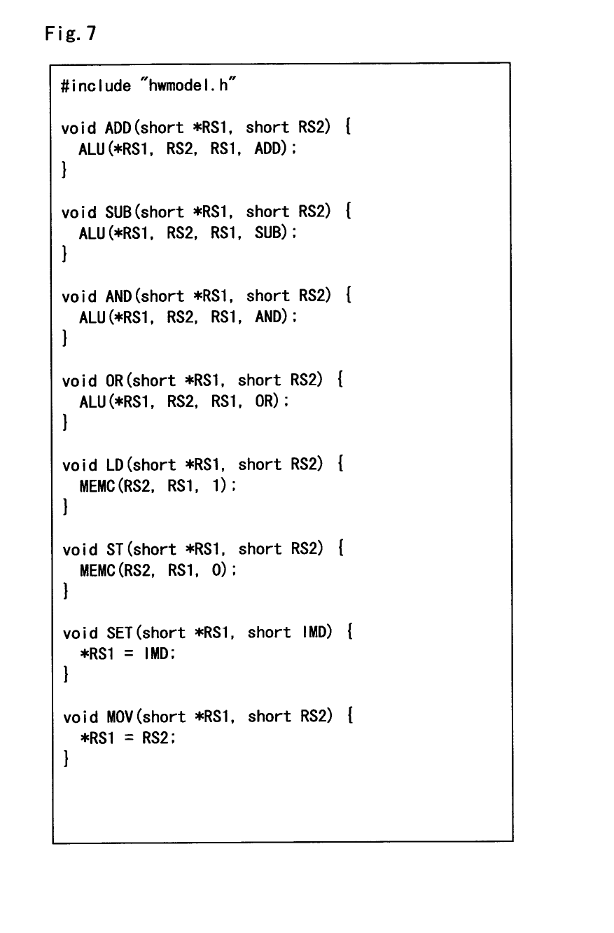

Referring now to FIG. 7, an example of an implement of the instruction-set-library 105 is explained, not in an object-code level but in a source code level.

As mentioned above, and as shown in FIG. 3(a), the target processor has eight kinds of instructions, that is, an ADD instruction, an SUB instruction, an AND instruction, an OR instruction, an LD instruction, an ST instruction, an SET instruction, and an MOV instruction.

In the instruction-set-library 105 of this embodiment, the following functions corresponding to each of these instructions are prepared.

As shown in FIG. 7, each of an ADD function, an SUB function, an AND function, and an OR function is defined as a function having two arguments RS1 and RS2, and operation of these functions is carried out by calling an ALU function 410 that is a library function of the hardware model library 101.

Here, the argument RS1 corresponds to the first-operand register, and the argument RS2 corresponds to the second-operand register, respectively.

Each of the LD function and the ST function is defined as a function having two arguments RS1 and RS2, and operation of these functions is carried out by calling the MEMC function 415 that is a library function of the hardware model library 101 and controls memories.

The argument RS1 corresponds to the first-operand register, and the argument RS2 corresponds to the second-operand register, respectively.

The SET function is defined as a function having two arguments RD and IMD, and substitutes the value of the argument IMD for a variable *RS1 assigned by the argument RS 1.

The MOV function is defined as a function having two arguments RD and RS, and substitutes the value of the argument RS2 for the variable *RS1 assigned by the argument RS1.

In this embodiment, the above eight instructions are prepared in the instruction-set-library 105.

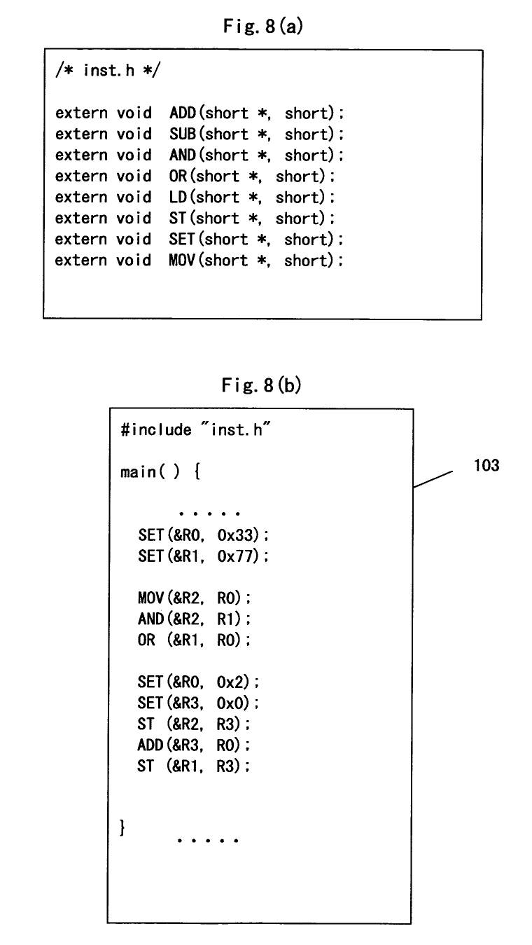

The header file as shown in FIG. 8(a) is prepared so that it may be easy to include the implement file of FIG. 7 in a source code.

Referring now to FIG. 8, an example of source code 103 shown in FIG. 2 is described.

In the source code 103 of FIG. 8, the header file shown in FIG. 8(a) is included at the beginning, and hereinafter each of functions implemented (See FIG. 7) in the instruction-set-library 105 can be used.

The SET function, the MOV function are called in a main function, and the called functions perform predetermined processes.

In this source code 103, not only the functions contained in the instruction-set-library 105 but also the functions that can be defined in C-language can be described, of course.

With this structure, calls are performed in order of the source code 103, the instruction-set-library 105 and the hardware model library 101.

Simulation of operation of the target processor can be carried out by compiling and executing this source code 103 using a compiler 104 running on the host processor, in which such as a personal computer or a workstation is mounted.

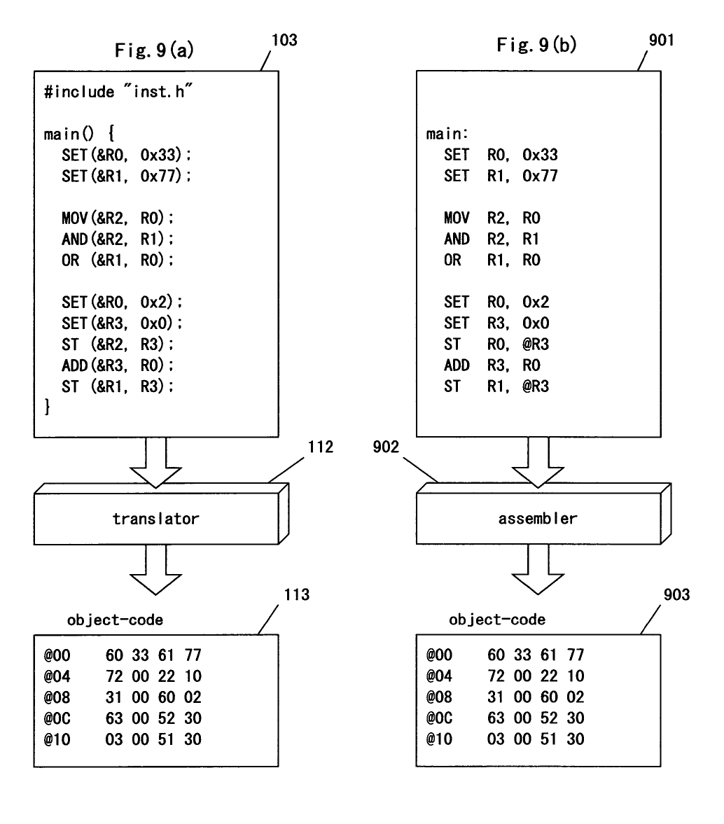

Referring now to FIG. 9, explanation is added about the interpreter type simulator 108 shown in FIG. 1. First, a translator 112 is explained.

FIG. 9(a) shows a flow of processing by the interpreter type simulator 108 of this embodiment, and FIG. 9(b) shows a flow in a case of processing by an assembler 902, respectively.

As shown in FIG. 9(a), the translator 112 of this embodiment needs to read the source code 103 (the same as the compiler type simulator 102) to output an object-code 113.

On the other hand, when there is an assembler program 901 corresponding to source code 103 (C-language), the assembler 902 assembles this assembler program 901 to output an object-code 903.

Herein, the purpose can be fulfilled if the object-code 113 is equal to the object-code 903.

Simply stated, it is sufficient if this translator 112 performs the following two processes (process 1 and process 2):

(process 1) The translator 112 inputs the source code 113 to replace the source code 103 with the assembler program 901; and

(process 2) The translator 112, having functions equivalent to the assembler 902, assembles the replaced assembler program 901.

More specifically, the process 1 can be performed by simple replacement of strings according to the following rules (rule 1, rule 2 and rule 3).

(rule 1) The translator 112 deletes lines including the string of “#include *”, where “*” is a wild card.

(rule 2) The translator 112 replaces the string of “main 0*” with the string of “main:”.

(rule 3) The translator 112 replaces the string of “SET (&*, ?)” with the string of “SET *, ?”, where “*” and “?” are wild cards.

In addition, the process 2 is easily performed substituting the assembler 902 for the functions equivalent thereto. Of course, specific functions equivalent to the assembler 902 may be provided for the translator 112.

The translator 112 needs not to perform the process 1 and the process 2 seperately, but may perform the processes 1 and 2 at once.

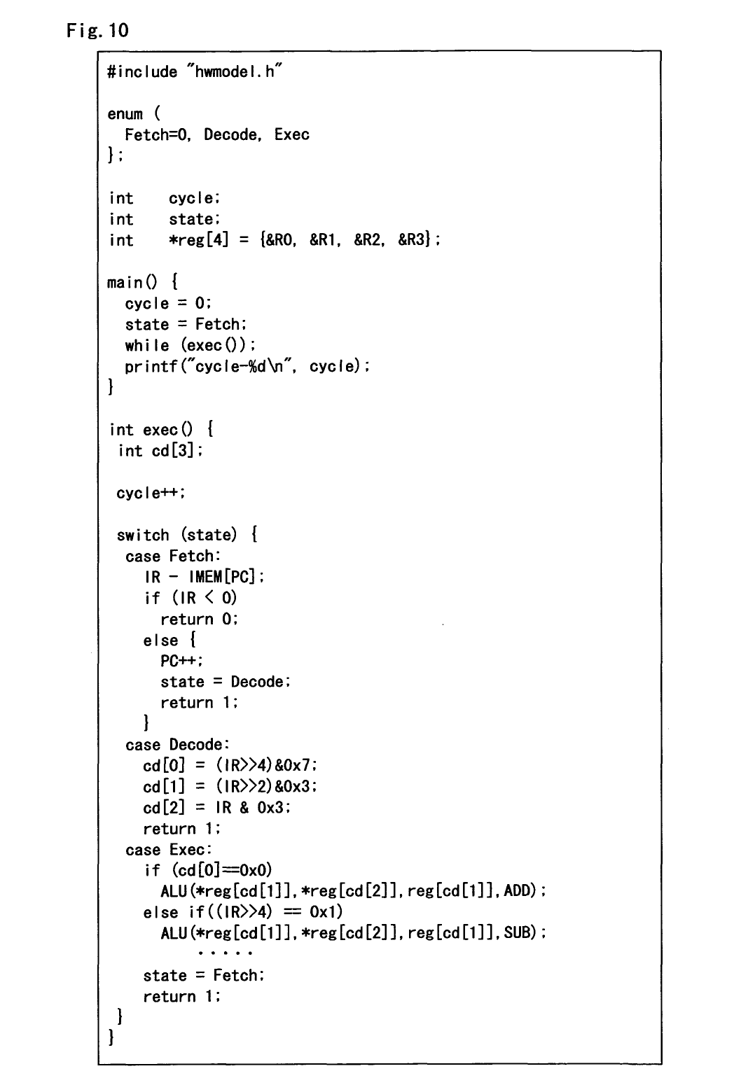

Referring now to FIG. 10, the instruction-fetching unit 109 of FIG. 1, the instruction-decoding unit 110 and the executing unit 111 will now be explained.

FIG. 10 is an illustration showing an example of the implement file of the interpreter type simulator in the first embodiment of the present invention. At the beginning of FIG. 10, the header file of the hardware model library 101 is included.

A type of variable “state” is declared enumerating only three values of “Fetch (=0)”, “Decode”, and “Exec”.

Of course, the instruction-fetching unit 109 should operate when the variable “state” is “Fetch”. Similarly, when the variables “state” is “Decode” or “Exec”, the instruction-decoding unit 110 or the executing unit 111 should operate, respectively.

A variable “cycle” that memorizes an executing-cycles-number is declared as int type and introduced.

In a main function, after setting the variable “cycle” to “0” and setting the variable “state” to “Fetch”, process starts.

In the next while sentence, an exec function is called and, at the end of the main function, a value of the variable “cycle” is outputted to the standard output. Thereby, the executing-cycles-number is acquired and measured.

Whenever the exec function is called, the variable “cycle” increases by one, hereinafter, in a switch sentence, process branches depending on the value of the variable “state”.

When the variable “state” is “Fetch”, process (from “case Fetch:” to just before “case Decode:”) equivalent to the instruction-fetching unit 109 is performed.

When the variable “state” is “Decode”, process (from “case Decode:” to just before “case Exec:”) equivalent to the instruction-decoding unit 110 is performed.

When the variable “state” is “Exec”, process (below “case Decode:”) equivalent to the executing unit 111 is performed.

Note that variables, arrays, functions, and so on, such as the array IMEM and the ALU function, are defined in the hardware model library 101 and are used, in each of the above processes.

<Effects of First Embodiment>

As mentioned above, development using the compiler type simulator 102 and the interpreter type simulator 108 earns high efficiency than the prior art, since the simulators 102 and 108 comprises the library that models components of the target processor by the functions and/or the procedures.

The instruction-set-library 105 can be constructed, only preparing and compiling a common source code, easier than the interpreter type simulator 108. Thereby, man-days decrease, and the compiler type simulator 102 can be supplied earlier than the interpreter type simulator 108.

The translator 112 generates, from the source code 103 described by the functions of the instruction-set-library 105, the same object-code as an object-code that an assembler has assembled an assembler code. Using the translator 112, a common source code can apply to both of two kinds of simulators 102 and 108.

(Second Embodiment)

Hereinafter, difference with a first embodiment is explained.

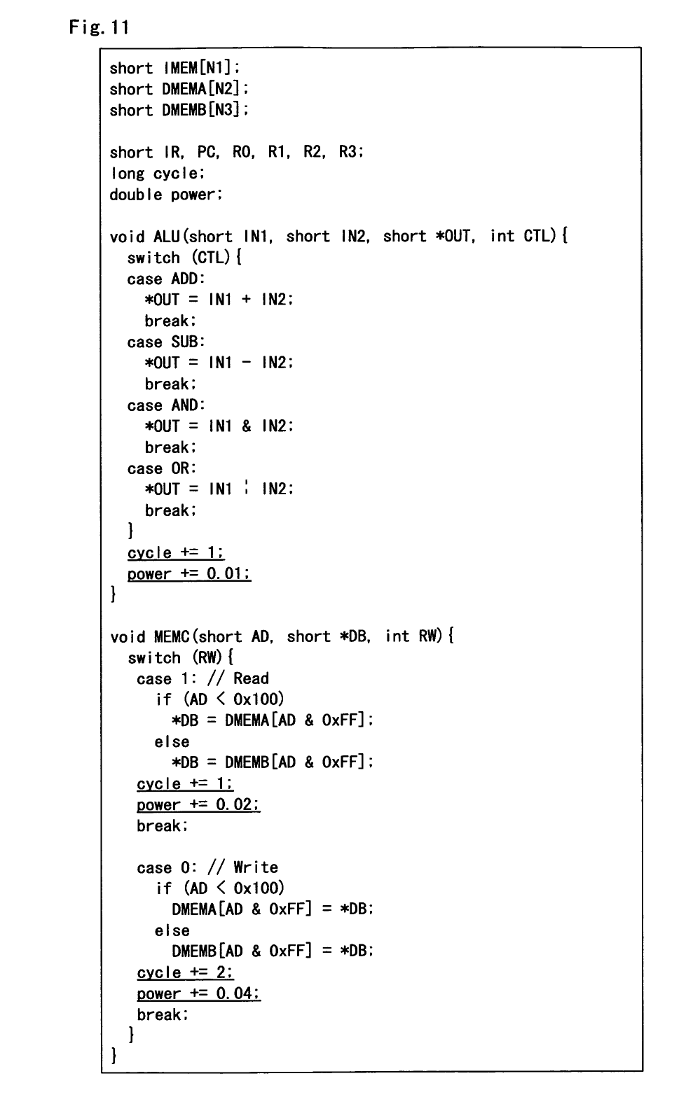

As shown in FIG. 11, in the hardware model library 101, a variable “cycle” showing an executing-cycles-number and a variable “power” showing power consumption are added.

In addition, in the ALU function, concerning ALU operation, an executing-cycles-number of ALU calculation is added to the variable “cycle” and power consumption of ALU calculation is added to the variable “power”.

In the MEMC function, concerning memory access, an executing-cycles-number of the memory access is added to the variable “cycle” and power consumption of the memory access is added to the variable “power”.

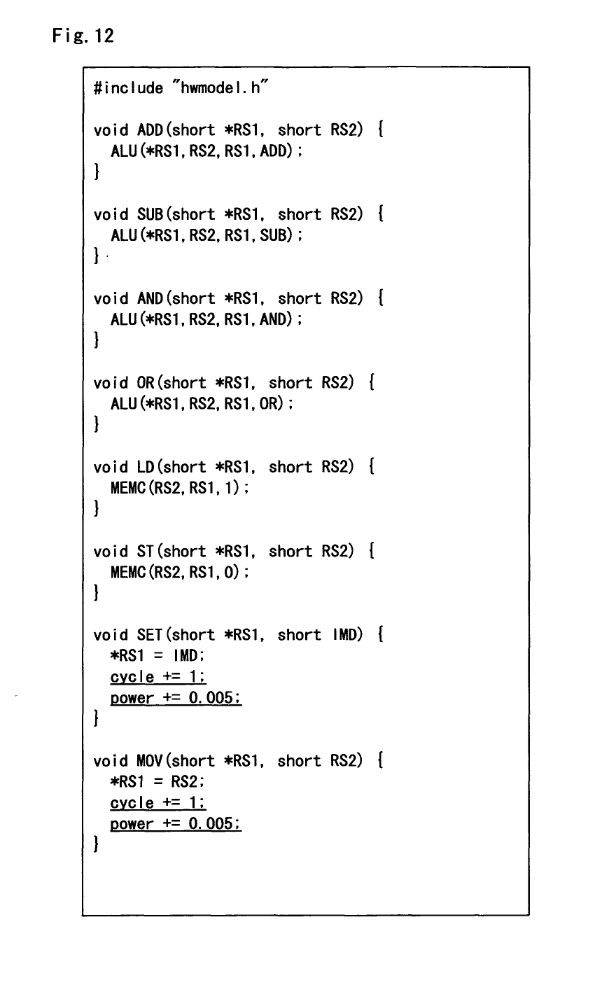

As shown in FIG. 12, in the instruction-set-library 105, in order to calculate the executing-cycles-number and the power consumption that are necessary for executing instructions using the SET function and the MOV function, a process adding the variables “cycle” and “power” is further included.

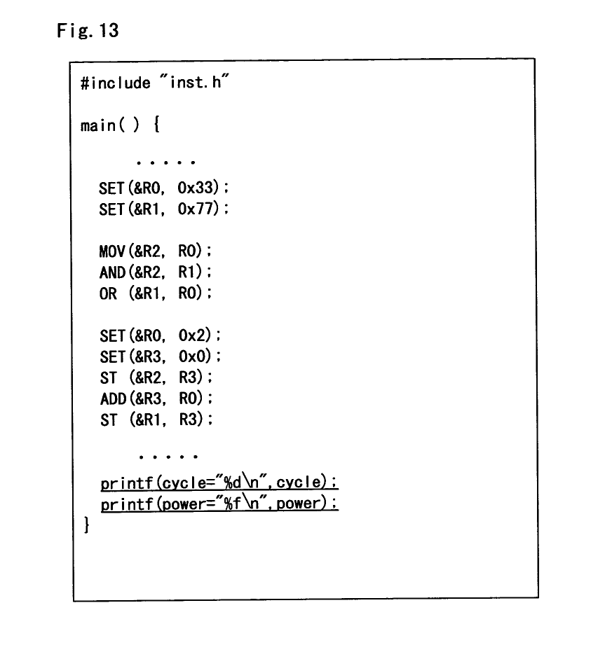

As shown in FIG. 13, in the source code 103, a sentence that carries out the standard output of the value of the variables “cycle” and “power” using a printf function is added.

Of course, instead of carrying out the standard output, the values of the variables “cycle” and “power” may be outputted to a file and so on. Thereby, information about the executing-cycles-number and the power consumption that program execution requires can be acquired and measured.

Although not illustrated, as for the interpreter type simulator 108 of the second embodiment, it is desirable to add, like the above, functions that carry out the standard output of the value of the variable “power” using a printf function, to the main function of FIG. 10.

Thereby, also in the interpreter type simulator 108, the information about the power consumption that program execution requires can be acquired and measured.

<Effects of Second Embodiment>

In addition to the effect of the first embodiment, since the library includes process that calculates the executing-cycles-number and the power consumption, making a corresponding variable output, the executing-cycles-number and the power consumption of the assembler program can be acquired and measured, when simulation ends. Performance can be analyzed in two kinds (compiler type and interpreter type) of simulators.

(Third Embodiment)

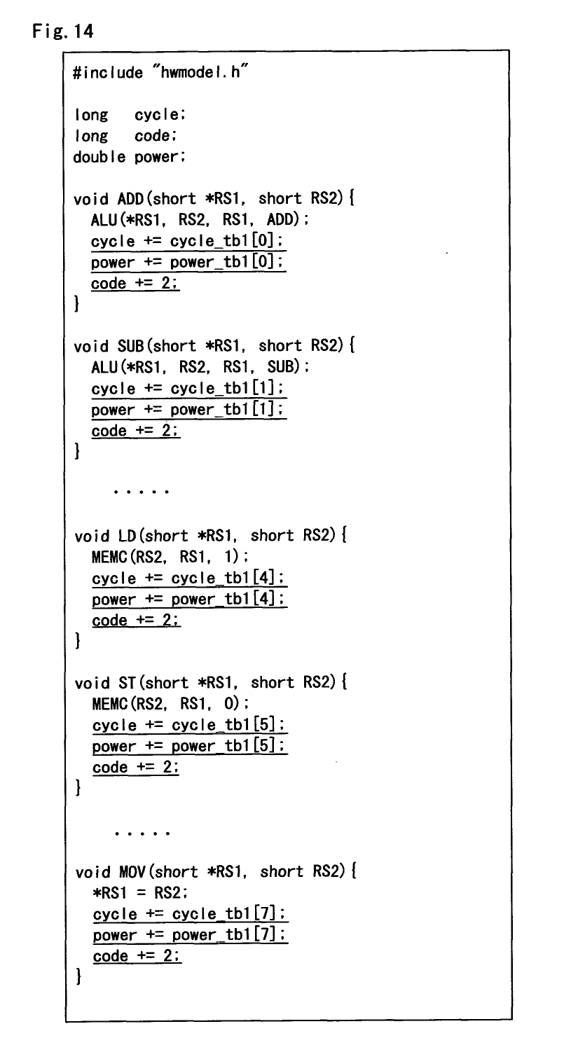

Only difference with the second embodiment is explained in a third embodiment. As shown in FIG. 14, in the instruction-set-library 105, a variable “cycle” showing an executing-cycles-number, a variable “power” showing power consumption, and a variable “code” showing code size are added.

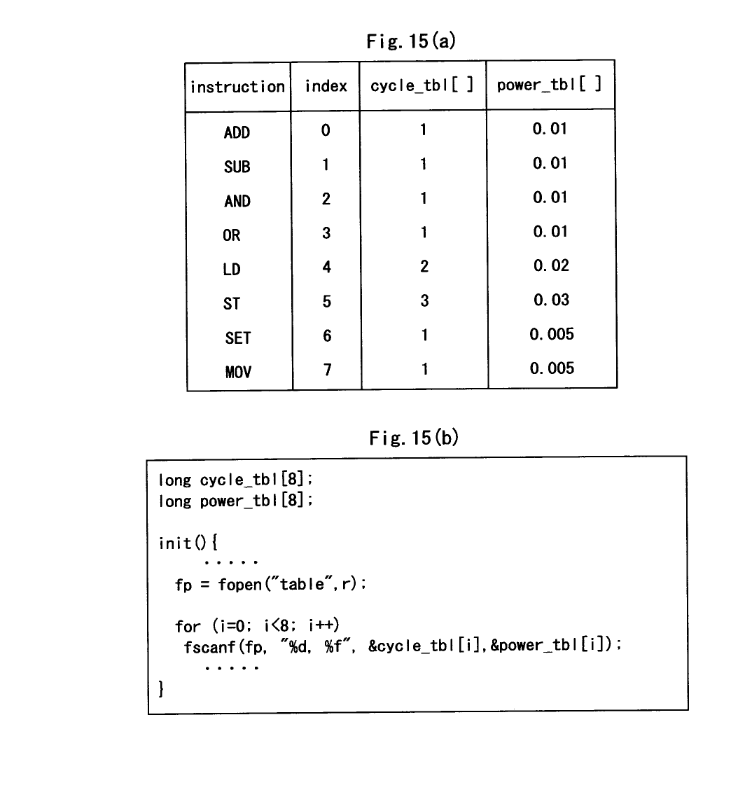

In this embodiment, as shown in a table of FIG. 15(a), a unique index is given for every instructions, such as the ADD instruction and the SUB instruction, an increment of the variable “cycle” and an increment of the variable “power” are defined, and such increments are stored in an array cycle_tbl [ ] and an array power_tbl[ ], respectively. Of course, such increments may be stored in other storing construction that is not an array.

As shown in FIG. 14, in the instruction-set-library 105, process adding these variables “cycle”, “power”, and “code” is added in the ADD function, the SUB function, the LD function, the ST function, and the MOV function, respectively.

When the variables “cycle” and “power” are calculated, the values of arrays cycle_tbl [ ] and power_tbl[ ] that are necessary for each instruction execution, are used.

As shown in an example of source code of FIG. 15(b), it is desirable to store data of values of arrays cycle_tbl [ ] and power_tbl[ ] in the file (in the example of illustration, “table” file), and to load, at the time of initialization, the values to arrays cycle_tbl [ ] and power_tbl[ ] from the file.

This init function is an initialization function to be executed before simulation starts.

<Effects of Third Embodiment>

In addition to the effect of the second embodiment, by adopting the mechanism of giving, from the outside (the file), information about the executing-cycles-number and the power consumption that instruction execution requires, it becomes able to change such information easily, and simulation according to various cases can be performed.

Although the example of description of the library that does not use object-orientation, the hardware model library 101 and the instruction-set-library 105 may be more smartly described with C++ language and so on, for example. In all of the embodiments, the compiler type simulator 102 and the interpreter type simulator 108 can be supplied with “recording medium” (e.g. CD-ROM, FD, hard disk, and so on.) storing programs performing the compiler type simulator 102 and/or the interpreter type simulator 108.

Furthermore, the simulators 102 and 103 can be supplied with a personal computer, a workstation, and so on, to which the programs are pre-installed.

It is noted that the “recording medium” mentioned in this specification includes a case in which the programs are divided and stored in a plurality of sets of record media and distributed.

Additionally, regardless of whether or not the program is a part of an operating system, if the program causes some of the functions thereof to be performed by various processes or threads (DLL, OCX, Active X, and so on, (including the trademarks of Microsoft Corporation)), the “recording medium” includes a case in which a part concerning the functions performed by them is not stored in the recording medium.

A standalone type system is shown in FIG. 1. A server/client type system can be used instead. In other words, instead of a case in which all components appearing in the specification are contained in only one terminal unit, a case is allowable in which one terminal unit is a client, and all of or a part of the components exist in a server or network connectable to the client.

A case is also allowable in which the server side has almost all the components of FIG. 1, and the client side has, for example, a WWW browser only. Normally, various kinds of information are located on the server, and are distributed to the client basically through a network. In this case, when necessary information is located on the server, a storage device of the server is the “recording medium” mentioned above, and, when the information is located on the client, a storage device of the client is the “recording medium”.

In addition to an application that is compiled in a form of a machine language, the “digital signature program” includes a case in which it exists as an intermediate code interpreted by the aforementioned process or thread, a case in which at least a resource and a source code are stored on the “recording medium”, and a compiler and a linker that can generate the application of a machine language from them are located on the “recording medium”, or a case in which at least the resource and the source code are stored on the “recording medium”, and an interpreter that can generate the application of the intermediate code from them is located on the “recording medium”.

According to the present invention, in developing a compiler type simulator and an interpreter type simulator by modeling components of the target processor using the functions and/or the procedures, parts of simulators can be communalized and development efficiency improves.

Including optimization of assembler level, all of software development can be done in a high-level language.

The common source code can be used in both the compiler type simulator and the interpreter type simulator, by adding the translator mentioned above.

Also in the compiler type simulator, performance can be analyzed by including in the library a process that calculates the executing-cycles-number, the power consumption, and the code size. Such information can be changed easily and the simulation according to various cases can be done.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A compiler type simulator for software development, said compiler type simulator comprising:
a compiler operable to compile a source code described in a high-level language; and
a library including at least one of a plurality of functions and a plurality of procedures that are defined in the high-level language and model components of a target processor different from a host processor,
wherein the source code is described using said library.

2. The compiler type simulator as recited in claim 1, wherein the components of the target processor comprise:
an accumulator of the target processor;
a memory controller of the target processor; and
a register of the target processor.

3. The compiler type simulator as recited in claim 1, wherein said library comprises:
a hardware model library defining in the high-level language the at least one of the plurality of functions and the plurality of procedures that model the components of the target processor; and
an instruction-set-library defining in the high-level language at least one of a plurality of functions and a plurality of procedures corresponding to instructions of the target processor using the at least one of the plurality of functions and the plurality of procedures of said hardware model library.

4. The compiler type simulator as recited in claim 3, wherein the instructions of the target processor comprise an ADD instruction, an SUB instruction, an AND instruction, an OR instruction, an LD instruction, an ST instruction, an SET instruction and an MOV instruction.

5. The compiler type simulator as recited in claim 1, wherein the at least one of the plurality of functions and the plurality of procedures of said library comprises a function and a procedure operable to calculate at least one of
an executing-cycles-number of the target processor and
power consumption of the target processor.

6. The compiler type simulator as recited in claim 1, wherein at least one of
an executing-cycles-number of the target processor and
power consumption of the target processor
can be changed.

7. The compiler type simulator as recited in claim 1, wherein the at least one of the plurality of functions and the plurality of procedures of said library comprises a function and a procedure operable to calculate code size in the target processor.

8. An interpreter type simulator for software development, said interpreter type simulator comprising:
a translator operable to read a source code described in a high-level language to output an object-code;
an instruction-fetching unit operable to fetch the object-code to output a fetched object-code;
an instruction-decoding unit operable to decode the fetched object-code to output a decoded object-code;
an executing unit operable to execute the decoded object-code; and
a library including at least one of a plurality of functions and a plurality of procedures that are defined in the high-level language and model components of a target processor different from a host processor,
wherein the source code is described using said library.

9. A simulation program recorded on a recoding medium, said simulation program comprising:
a compiler operable to compile a source code described in a high-level language; and
a library including at least one of a plurality of functions and a plurality of procedures that are defined in the high-level language and model components of a target processor different from a host processor,
wherein the source code is described using said library.
